(19) United States
(12) Patent Application Publication
(10) Pub. No.: US 2005/0286260 A1
(43) Pub. Date: Dec. 29, 2005

(54) Method of producing an LED rope light

(76) Inventors: Wei-Lien Liu, Hsinchu City (TW); Lee-Ven Liu, Hsinchu City (TW); Warren Liu, Taipei County (TW)

Correspondence Address: Wei-Lien Liu, 7F., No. 213, Civic Boulevard. Sec. 4, Taipei, 105, TW

(21) Appl. No.: 10/874,868

(22) Filed: Jun. 23, 2004

(51) Int. Cl. F21V 7/04

(52) U.S. Cl. 362/551

(57) ABSTRACT

A method for producing an LED rope light mainly includes the steps of providing first and second protrusions on two conductive terminals of each metal wire to distinctively indicate positive and negative polarities thereof; serially connecting a plurality of LED lamps to form an LED light string; associating the LED light string with a power cord holder; and positioning the power cord holder with the LED light string in an outer tube having a corrugated inner wall surface. When the LED light string is supplied with power, light emitted from the LED lamps is refracted by the corrugated inner wall surface of the outer tube to provided expanded illuminating areas and softened light.

### FIELD OF THE INVENTION

The present invention relates to a method of producing an LED rope light, of which light emitted from a plurality of internal LED light strings is refracted by a corrugated inner wall surface of an outer tube of the LED rope light to provide expanded illuminating areas, and light spots are expanded to form curved and softened lighting areas.

### BACKGROUND OF THE INVENTION

A conventional rope light includes a plurality of bulbs as its light sources. These bulbs are serially connected to one another to form one or two bulb strings, which are then set in a long core tube. The core tube is cut at an outer surface to provide a longitudinal opening, via which the bulb string or strings are positioned into the core tube. Two power cords having different polarities are embedded in two opposite sides of a wall of the core tube. The two embedded power cords are cut at staggered positions to expose bare conductors, to which lead wires of the first and the last bulb in the bulb strings are separately electrically connected to get power for emitting light. The core tube with bulbs is then drawn into a transparent outer tube to complete a conventional rope light. In the case two bulb strings are formed, lead wires of the bulbs must be covered with insulated sleeves to avoid a short circuit.

In the above-described conventional rope light, the bulbs are horizontally set into the core tube via the longitudinal opening provided on one side of the core tube. The existence of the longitudinal opening largely reduces an overall structural strength of the core tube. When the rope light is used on a stage or at places close to steps and tends to be twisted, deformed, trodden or impacted, the core tube with reduced structural strength is not strong enough to bear such external forces, resulting in damaged bulbs in the core tube. Moreover, it is difficult and requires increased material and labor costs to mount the insulated sleeves around the lead wires of two adjacent bulb strings that are set in the core tube at the same time. The conventional rope light with two bulb strings therefore requires increased material cost and is not easy to assemble.

Another problem with the conventional rope light is that the bulbs consume high power and generate a large amount of heat to cause quick deterioration of core tube and plastic outer tube of the rope light. Broken bulbs in the deteriorated core tube and outer tube tend to cause short circuit, and the conventional rope light is therefore not safe for use.

It is therefore tried by the inventor to develop a method of producing an LED rope light that eliminates the problems existed in the conventional rope light.

### SUMMARY OF THE INVENTION

A primary object of the present invention is to provide a method of producing an LED rope light, of which light emitted from a plurality of internal LED light strings is refracted by a corrugated inner wall surface of an outer tube of the LED rope light to provide expanded illuminating areas, and light spots are expanded to form curved and softened lighting areas.

To achieve the above and other objects, the method of producing an LED rope light according to the present invention includes the steps of (1) preparing a plurality of metal wires, each of which has two silver-plated conductive terminals connected to two ends thereof; the two conductive terminals of each of the metal wires are respectively provided on the same side with a first and a second conductive protrusion that have different shapes to distinctively indicate a positive and a negative polarity of the two conductive terminals; (2) symmetrically positioning two conductive terminals of different polarities on two metal wires in a light seat; (3) fixedly mounting an LED chip on each of the first conductive protrusions, and connecting a metal conductor at two ends thereof to a top of the LED chip and the second protrusion, respectively, for each light seat; (4) forming a clear hood over each light seat, so as to protect the LED chip and the metal conductor and form a complete LED lamp, and to form an LED light string when a plurality of the LED lamps are completed; (5) mounting the LED light string in a power cord holder having embedded positive and negative power cords for electrically connecting to the LED light string; (6) positioning the power cord holder with the LED light string mounted therein in an outer tube having a corrugated inner wall surface; and (7) attaching a power connection to an end of the outer tube, so that power is supplied to the LED light string connected to the power cord holder via the power connection.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 illustrates the first step of the method of the present invention for producing an LED rope light;

FIG. 2 illustrates the second step of the method of the present invention for producing an LED rope light;

FIG. 3 illustrates the third step of the method of the present invention for producing an LED rope light;

FIG. 4 illustrates the fourth step of the method of the present invention for producing an LED rope light;

FIG. 5 illustrates the fifth step of the method of the present invention for producing an LED rope light;

FIG. 6 illustrates the sixth step of the method of the present invention for producing an LED rope light;

FIG. 7 illustrates the seventh step of the method of the present invention for producing an LED rope light;

FIG. 8 is an exploded perspective view illustrating differently shaped power cord holder and outer tube are used in the fifth and the sixth step of the method of the present invention for producing an LED rope light;

FIG. 9 is an assembled perspective view of FIG. 8;

FIG. 10 is a cross sectional view of FIG. 9; and

FIG. 11 shows a finish product of the LED rope light produced with the method of the present invention using the power cord holder and the outer tube shown in FIG. 8.

### DETAILED DESCRIPTION OF THE PREFERRED EMBODIMENTS

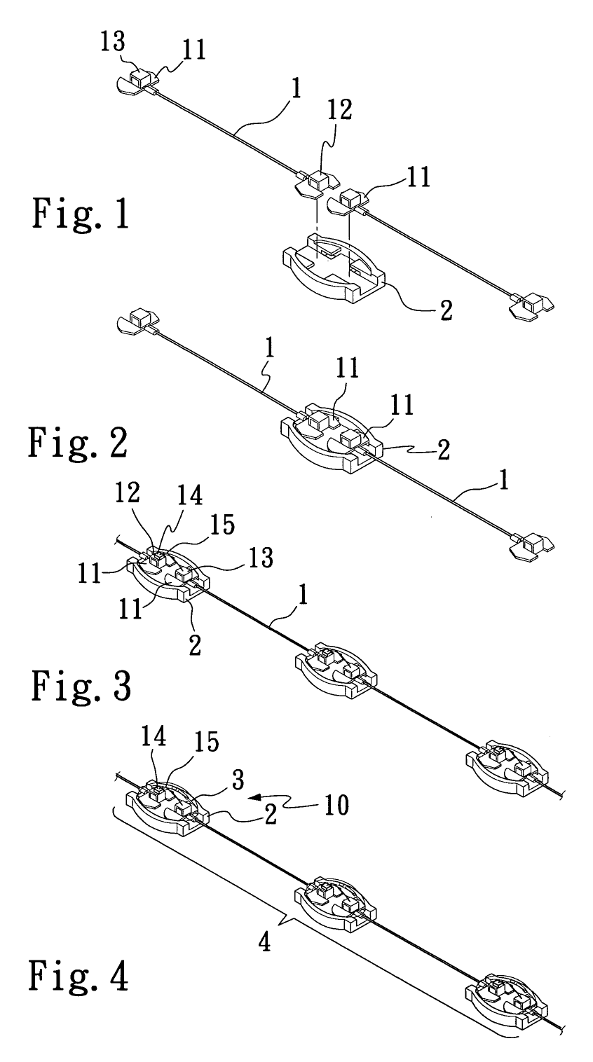

Please refer to FIGS. 1 to 7 that sequentially shows seven main steps included in the method of the present invention for producing an LED rope light.

In the first step of the method of the present invention as shown in FIG. 1, a plurality of metal wires 1 each having two silver-plated conductive terminals 11 connected to two ends thereof are prepared. The two conductive terminals 11 of each of the metal wires 1 are respectively provided on the same side with a first and a second conductive protrusion 12, 13 that have different shapes to distinctively indicate a positive and a negative polarity of the two conductive terminals 11. In the illustrated embodiment, the first and the second protrusions 12, 13 are square and round in shape, respectively.

In the second step of the method of the present invention as shown in FIG. 2, two conductive terminals 11 of different polarities on two metal wires 1 are symmetrically positioned in a light seat 2.

In the third step of the method of the present invention as shown in FIG. 3, an LED chip 14 is fixedly mounted on each of the first conductive protrusions 12 of the conductive terminals 11 in the light seats 2, and a metal conductor 15 is connected at two ends to a top of the LED chip 14 and the second protrusion 13, respectively, for each light seat 2.

In the fourth step of the method of the present invention as shown in FIG. 4, a hood 3 is formed over each light seat 2 using an epoxy material, so as to protect the LED chip 14 and the metal conductor 15, and form a complete LED lamp 10. When a plurality of the LED lamps 10 are completed on the light seats 2, an LED light string 4 is obtained.

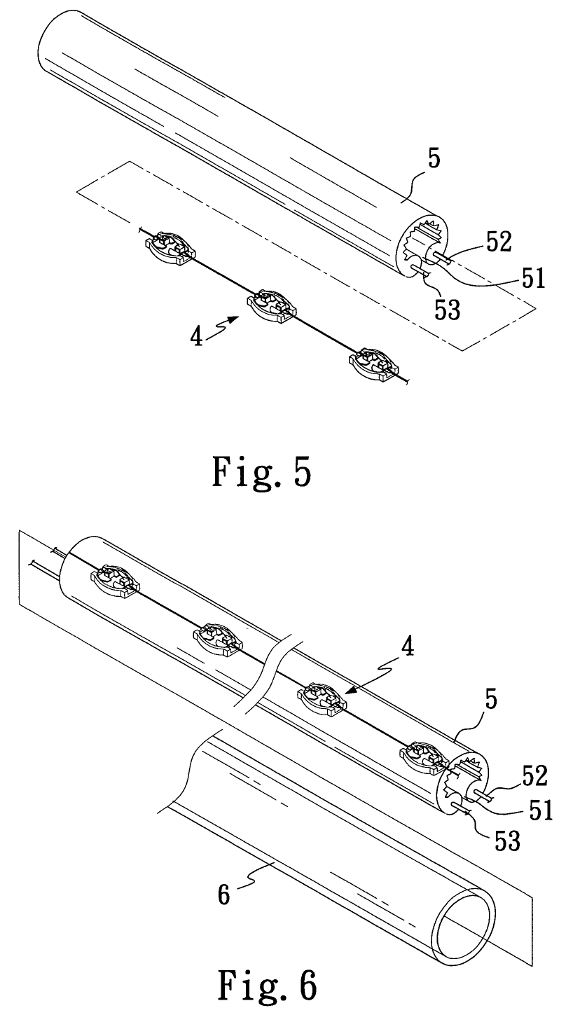

In the fifth step of the method of the present invention as shown in FIG. 5, the LED light string 4 is mounted in a power cord holder 5, which is in the form of a core tube in the illustrated embodiment. The core tube 5 is provided at one side with an axially extended and elastically expandable opening 51. Two free edges of the opening 51 have expanded thickness for a positive and a negative power cord 52, 53 to embed therein, so that the LED light string 4 mounted in the core tube 5 may be electrically connected to the positive and the negative power cords 52, 53. Moreover, the core tube 5 is provided with a corrugated inner wall surface. In the sixth step of the method of the present invention as shown in FIG. 6, the core tube 5 with the LED light string 4 mounted therein is positioned in an outer tube 6.

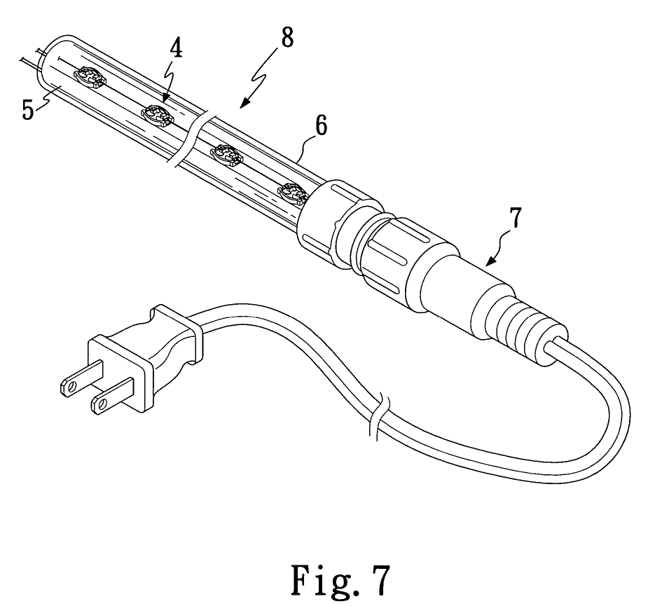

In the seventh step of the method of the present invention as shown in FIG. 7, a power connection 7 is attached to an end of the outer tube 6 to supply power to the LED light string 4 in the core tube 5 via the power connection 7. And, a complete LED rope light 8 is formed.

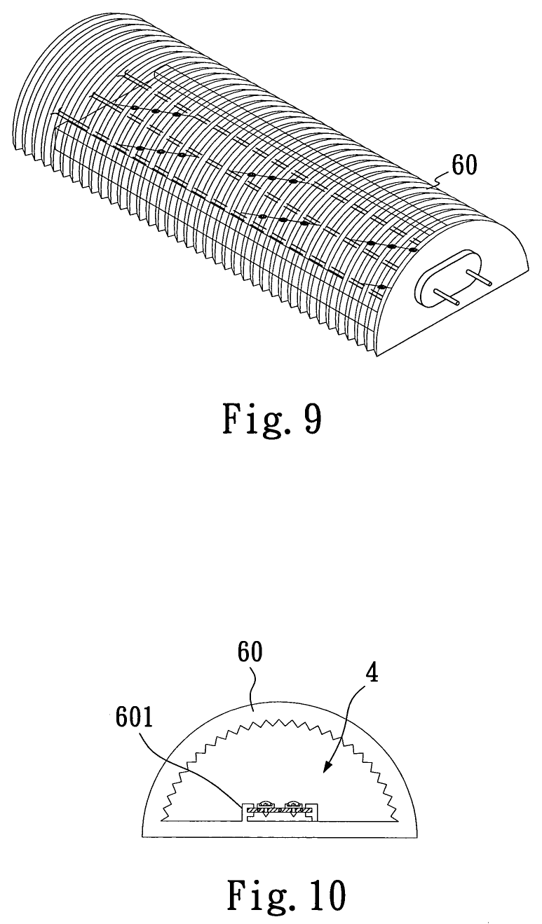

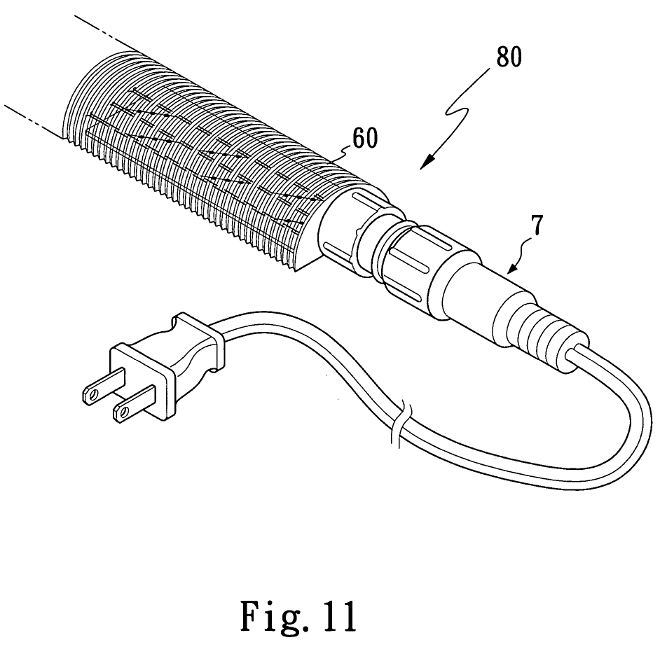

FIG. 9 shows differently shaped core plate or power cord holder 50 and outer tube 60 are used in the fifth and the sixth step of the present invention to replace the core tube 5 and the outer tube 6.

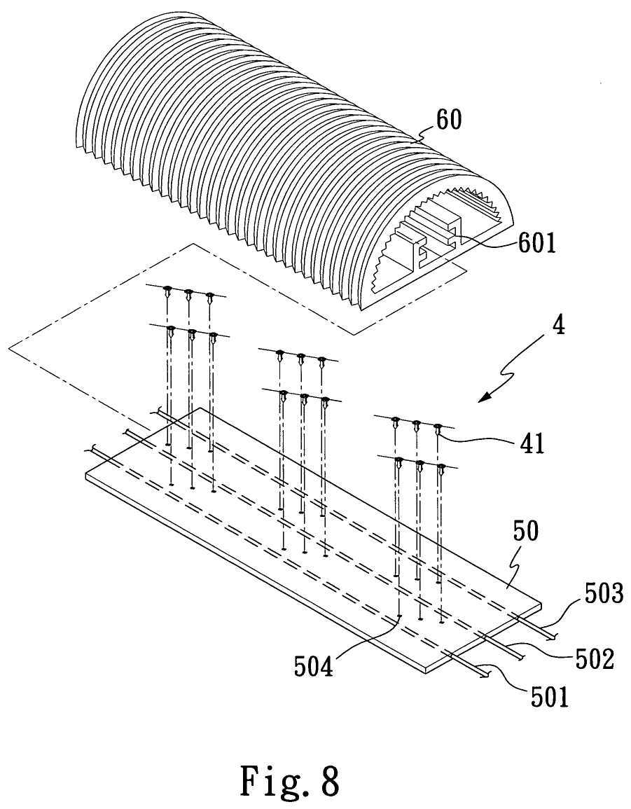

The core plate 50 is internally provided with three parallelly spaced power cords 501, 502, 503 having positive, negative, and positive polarities, respectively. A plurality of through holes 504 are preformed on a top of the core plate 50, so that barbs 41 provided at a bottom of each LED light string 4 may be extended through and hooked to the through holes 504. The outer tube 60 has a semicircular cross section dimensioned for the core plate 50 to implant therein. Two substantially F-sectioned supports 601 are symmetrically provided in the outer tube 60 on a flat bottom thereof to form a pair of sliding rails, on and between which the core plate 50 is slidably supported. Both of the two F-sectioned supports 601 have a length equal to a full length of the outer tube 60. Moreover, a curved portion of the semicircular outer tube 60 has a corrugated inner wall surface. Two lateral outer wall surfaces of the curved portion of the outer tube 60 are provided with transverse folds, and a top of the curved portion of the outer tube 60 is provided with a plurality of transverse fine grooves, so that the semicircular outer tube 60 is easily flexible. FIG. 9 is an assembled perspective view of FIG. 8, and FIG. 10 is a cross sectional view of FIG. 10. Again, a power connection 7 is attached to an end of the outer tube 60 to supply power to the LED light string 4 on the core plate 50 via the power connection 7. And, a complete LED rope light 80 is formed.

With the method of the present invention, an LED rope light 8, 80 may be produced at largely reduced material. Since the LED light strings 4 are formed from LED lamps 10 that are formed on serially connected light seats 2 using metal wires 1, it is not necessary to test the LED lamps 10 one by one. When the LED light strings 4 are supplied with power to emit light, the emitted light is refracted by the corrugated inner wall surface of the core tube 5 or the outer tube 60 to provide expanded illuminating areas, and light spots on the core tube 5 or the outer tube 60 are expanded to form curved and softened lighting areas.

The present invention has been described with some preferred embodiments thereof and it is understood that many changes and modifications in the described embodiments can be carried out without departing from the scope and the spirit of the invention that is intended to be limited only by the appended claims.

1. A method of producing an LED rope light, comprising the steps of:
(1) preparing a plurality of metal wires, each of which has two silver-plated conductive terminals connected to two ends thereof; said two conductive terminals of each of said metal wires being respectively provided on the same side with a first and a second conductive protrusion that have different shapes to distinctively indicate a positive and a negative polarity of said two conductive terminals;
(2) symmetrically positioning two said conductive terminals of different polarities on two said metal wires in a light seat;
(3) fixedly mounting an LED chip on each of said first conductive protrusions, and connecting a metal conductor at two ends thereof to a top of said LED chip and said second protrusion, respectively, for each said light seat;
(4) forming a clear molding cover over each said light seat, so as to protect said LED chip and said metal conductor and form a complete LED lamp, and to form an LED light string with units of said completed LED lamps;
(5) mounting said LED light string in a power cord holder that has embedded positive and negative power cords for electrically connecting to said LED light string;
(6) positioning said power cord holder with said LED light string mounted therein in an outer tube having a corrugated inner wall surface; and
(7) attaching a power connection to an end of said outer tube, so that power is supplied to said LED light string connected to said power cord holder via said power connection.

2. The method of producing an LED rope light as claimed in claim 1, wherein said first and said second protrusions are square and round in shape, respectively.

3. The method of producing an LED rope light as claimed in claim 1, wherein said power cord holder used in the step (5) is a core tube being provided at one side with an axially extended and elastically expandable opening, two free edges of said opening having expanded thickness for said positive and said negative power cord to embed therein, and said core tube having a corrugated inner wall surface.

4. The method of producing an LED. rope light as claimed in claim 1, wherein said power cord holder used in the step (5) is a core plate being internally provided with three parallelly spaced power cords having positive, negative, and positive polarities, respectively; and a plurality of through holes being preformed on a top of said core plate for said LED light string to engage therewith.

5. The method of producing an LED rope light as claimed in claim 1, wherein said outer tube used in the step (6) has a semicircular cross section, two lateral outer wall surfaces of a curved portion of said semicircular outer tube being provided with transverse folds, and two substantially F-sectioned supports are symmetrically provided in said outer tube on a flat bottom thereof to form a pair of sliding rails, on and between which a core plate is slidably supported, both said two F-sectioned supports having a length equal to a full length of said outer tube; and a top of said curved portion of said outer tube being provided with a plurality of transverse fine grooves, so that said semicircular outer tube is easily flexible.
